(19) United States
(12) Patent Application Publication
(10) Pub. No.: US 2026/0257170 A1
(43) Pub. Date: Sep. 3, 2026

(54) SORBENT MATERIALS FOR CO2 CAPTURE, USES THEREOF AND METHODS FOR MAKING SAME

(71) Applicant: CLIMEWORKS AG, Zürich (CH)

(72) Inventors: Gerald BAUER, Zürich (CH); Davide ALBANI, Zürich (CH); Cornelius GROPP, Zürich (CH)

(73) Assignee: CLIMEWORKS AG, Zürich (CH)

(21) Appl. No.: 18/876,018

(22) PCT Filed: Jun. 23, 2023
(86) PCT No.: PCT/EP2023/067067

§ 371 Date: Dec. 17, 2024

(30) Foreign Application Priority Data
Jun. 29, 2022 (EP) 22181781.0

(51) Int. Cl. B01D 53/62; B01D 53/82; B01D 53/96

(52) U.S. Cl. CPC B01D 53/62; B01D 53/82; B01D 53/96; B01D 2253/20; B01D 2257/504; B01D 2258/06; B01D 2259/4009

(57) ABSTRACT

A method for separating carbon dioxide from a gas mixture by cyclic adsorption/desorption using a sorbent having the following sequential repeating steps (a)-(e): (a) contacting gas mixture with sorbent to allow at least gaseous carbon dioxide to adsorb in an adsorption step; (b) isolating the sorbent in the unit; (c) inducing an increase of the temperature starting the desorption of CO2; (d) extracting at least the desorbed gaseous carbon dioxide and separating gaseous carbon dioxide; (e) bringing the sorbent to ambient atmospheric temperature and pressure. The sorbent has a packed bed of a mixture of 82-98 wt.-% of first particles of support material functionalised with primary or secondary amines, capable of reversibly binding carbon dioxide, and 2-18 wt.-% of second particles of support material which are non-functionalised and/or which are functionalised but where the functionalisation is deactivated.

### TECHNICAL FIELD

The present invention relates to carbon dioxide capture materials with primary and/or secondary amine carbon dioxide capture moieties, as well as to methods for preparing such capture materials, and to uses of such capture materials in particular in direct air capture processes.

### PRIOR ART

According to the OECD report of 2017 [Global Energy & CO2 Status Report 2017, OECD/IEA March 2018] the yearly emissions of CO2 to the atmosphere are ca 32.5 Gt (Gigatons, or 32.5×10E9 tons). As of February 2020 all but two of the 196 states that in 2016 have negotiated the Paris Agreement within the United Nations Framework Convention on Climate Change (UFCCC) had ratified it. The meaning of this figure is that a consensus at the time was reached regarding the threat of climate change and regarding the need of a global response to keep the rise of global temperature well below 2 degrees Celsius above pre-industrial levels.

The technical and scientific community engaged in the challenge of proposing solutions to meet the target of limiting CO2 emissions to the atmosphere and to remove greenhouse gases from the atmosphere has envisioned a number of technologies. Flue gas capture, or the capture of CO2 from point sources, such as specific industrial processes and specific CO2 emitters, deals with a wide range of relatively high concentrations of CO2 (3-100 vol %) depending on the process that produces the flue gas. High concentrations make the separation of the CO2 from other gases thermodynamically more favorable and consequently economically favorable as compared to the separation of CO2 from sources with lower concentrations, such as ambient air, where the concentration is in the order of 400 ppmv. Nonetheless, the very concept of capturing CO2 from point sources has strong limitations: it is specifically suitable to target such point sources, but is inherently linked to specific locations where the point sources are located and can at best limit emissions and support reaching carbon neutrality, while as a technical solution it will not be able to contribute to negative emissions (i.e., permanent removal of carbon dioxide from the atmosphere) and to remove emission from the past. In order to achieve negative emissions (i.e., permanent removal carbon dioxide from the atmosphere), the three most notable solutions currently applied, albeit being at an early stage of development, are the capturing of CO2 by means of vegetation (e.g. trees and plants, but not really permanent removal) using natural photosynthesis, by means of combining bioenergy from combustion of biomass with point source CO2 capture and subsequent permanent storage (BECCS) and by means of DAC and carbon dioxide storage technologies, which also results in permanent removal but a significantly reduced land footprint compared to BECCS.

Forestation has broad resonance with the public opinion. However, the scope and feasibility of re-forestation projects is debated and is likely to be less simple an approach as believed because it requires a large footprint in terms of occupied potentially arable land surface to captured CO2 ratio. BECCS suffers from the same shortcoming. On the other hand, DAC coupled with carbon dioxide storage technologies has lower land footprint and therefore it does not compete with the production of crops, can permanently remove CO2 from the atmosphere and can be deployed everywhere on the planet.

The above-described strategies to mitigate climate change all have potential and are considered as a potential part of the overall solution. The most likely future scenario is the deployment of a mix of such approaches, after undergoing further development.

Several DAC technologies were described, such as for example, the utilization of alkaline earth oxides to form calcium carbonate as described in US-A-2010034724. Different approaches comprise the utilization of solid CO2 adsorbents, hereafter named sorbents, in the form of packed beds of typically sorbent particles and where CO2 is captured at the gas-solid interface. Such sorbents can contain different types of amino functionalisation and polymers, such as immobilized aminosilane-based sorbents as reported in U.S. Pat. No. 8,834,822, and amine-functionalised cellulose as disclosed in WO-A-2012/168346.

WO-A-2011/049759 describes the utilization of an ion exchange material comprising an aminoalkylated bead polymer for the removal of carbon dioxide from industrial applications.

WO-A-2016/037668 describes a sorbent for reversibly adsorbing CO2 from a gas mixture, where the sorbent is composed of a polymeric adsorbent having a primary amino functionality. The materials can be regenerated by applying pressure or humidity swing.

Several academic publications, such as Alesi et al. in Industrial & Engineering Chemistry Research 2012, 51, 6907-6915; Veneman et al. in Energy Procedia 2014, 63, 2336; Yu et al. in Industrial & Engineering Chemistry Research 2017, 56, 3259-3269, also investigated in detail the use of cross-linked polystyrene resins functionalised with primary benzyl-amines as solid sorbents for DAC applications.

The state-of-the-art technology to capture CO2 from point sources typically uses liquid amines, as for example in industrial scrubbers, where the flue gas flows into a solution of an amine (U.S. Pat. No. 9,186,617). Other technologies are based on the use of solid sorbents in either a pack-bed or a flow-through structure configuration, where the sorbent is made of impregnated or covalently bound amines onto a support.

Amines react with CO2 to form of a carbamate moiety, which in a successive step can be regenerated to the original amine, for example by increasing the temperature of the sorbent bed to ca. 100° C. and therefore releasing the CO2. An economically viable process for carbon capture implies the ability to perform the cyclic adsorption/desorption of CO2 for hundreds or thousands of cycles using the same sorbent material without or with little loss of sorbent performance and without damaging the mechanical integrity of the adsorption unit.

More recently, structured adsorbers have also been employed for capturing CO2 from flue gas, such as the structures described by WO-A-2010096916 and WO-A-2018085927, that specify parallel passage contactors for the purpose of flue gas CO2 capture. These adsorber structures in their configuration for flue gas capture are designed for the high concentrations of CO2 present in flue gas and operate with the aim of capturing a high fraction of CO2 from the flue gas.

U.S. Pat. No. 8,262,774 discloses a process for forming a CO2 capture element which comprises providing a mixture of a monomer or monomer blend or a polymer binder, a miscible liquid carrier for the binder and a CO2 sorbent or getter in particle form, forming the mixture into a wet film or membrane, evaporating the liquid carrier to form a film or membrane, and treating the wet film or membrane to form pores in the body of the film or membrane. Also disclosed is a process of forming a CO2 capture element which comprises the steps of applying a mixture including a sorbent material and a polymer to an underlying material; polymerizing the mixture in place on the material; and aminating the polymer-coated material.

US-A-2007217982 discloses an apparatus for capture of CO2 from the atmosphere comprising an anion exchange material formed in a matrix exposed to a flow of the air.

U.S. Pat. No. 8,999,279 provides a method for removing carbon dioxide from a gas stream without consuming excess energy, wherein a solid sorbent material is used to capture the carbon dioxide. The solid sorbent material may utilize a water-swing for regeneration. Various geometric configurations are disclosed for advantageous recovery of CO2 and regeneration of the sorbent material.

U.S. Pat. Nos. 7,708,806 and 9,861,933 relate to a method and apparatus for extracting CO2 from air comprising an anion exchange material formed in a matrix exposed to a flow of the air, and for delivering that extracted CO2 to controlled environments. The present invention contemplates the extraction of CO2 from air using conventional extraction methods or by using one of the extraction methods disclosed, e.g., humidity swing or electrodialysis. The present invention also provides delivery of the CO2 to greenhouses where increased levels of CO2 will improve conditions for growth. Alternatively, the CO2 is fed to an algae culture. U.S. Pat. No. 8,715,393 discloses a method for removing carbon dioxide from a gas stream, comprising placing the gas stream in contact with a resin, wetting the resin with water, collecting water vapor and carbon dioxide from the resin, and separating the carbon dioxide from the water vapor. The resin may be placed in a chamber, or a plurality of chambers connected in series, wherein the first chamber contains resin that was first contacted by the gas, and each successive chamber contains resin which has been wetted and carbon dioxide collected from for a greater period of time than the previous chamber, and so on, until the last chamber. Secondary sorbents may be employed to further separate the carbon dioxide from the water vapor.

U.S. Pat. No. 9,527,747 provides a method and apparatus for extracting CO2 from a fluid stream and for delivering that extracted CO2 to controlled environments for utilization by a secondary process. Various extraction and delivery methods are disclosed specific to certain secondary uses, included the attraction of CO2 sensitive insects, the ripening and preservation of produce, and the neutralization of brine.

U.S. Pat. No. 8,088,197 and US-B-10010829 are directed to methods for removing CO2 from air, which comprises exposing sorbent covered surfaces to the air. The invention also provides for an apparatus for exposing air to a CO2 sorbent. In another aspect, the invention provides a method and apparatus for separating CO2 bound in a sorbent.

WO-A-2022013197 discloses a method for separating gaseous carbon dioxide from a gas mixture, e.g. from at least one of ambient atmospheric air, flue gas and biogas, by cyclic adsorption/desorption using a sorbent material, wherein the method comprises at least the following sequential and in this sequence repeating steps (a)-(e): (a) contacting said gas mixture with the sorbent material to allow gaseous carbon dioxide to adsorb; (b) isolating said sorbent material from said flow-through; (c) inducing an increase of the temperature of the sorbent material; (d) extracting at least the desorbed gaseous carbon dioxide from the unit and separating gaseous carbon dioxide from steam in or downstream of the unit (8); (e) bringing the sorbent material to ambient atmospheric conditions; wherein said sorbent material comprises primary and/or secondary amine moieties immobilized on a solid support, wherein the amine moieties, in the α-carbon position, are substituted by one hydrogen and one non-hydrogen substituent (R).

### SUMMARY OF THE INVENTION

It is an object of the present invention to provide for improved methods for separating gaseous carbon dioxide from a gas mixture, in particular from atmospheric air, and to provide for corresponding sorbent structures that are long lasting, easy to produce and that show high carbon dioxide capture capacity over a large number of cycles of corresponding capture adsorption and desorption.

According to a first aspect of the present invention, it relates to a method as defined in claim 1.

More specifically, the present invention relates to a method for separating gaseous carbon dioxide from a gas mixture, preferably from at least one of ambient atmospheric air, flue gas and biogas, containing said gaseous carbon dioxide as well as further gases different from gaseous carbon dioxide, by cyclic adsorption/desorption using a sorbent material adsorbing at least part of said gaseous carbon dioxide in a unit.

According to the proposed method, it comprises at least the following sequential and in this sequence repeating steps (a)-(e):
(a) contacting said gas mixture with the sorbent material to allow at least said gaseous carbon dioxide (parts thereof or essentially all of the carbon dioxide) to adsorb on the sorbent material by flow-through through said unit (and thus through and/or over the sorbent material adsorbing at least part of said gaseous carbon dioxide) under ambient atmospheric pressure conditions and ambient atmospheric temperature conditions in an adsorption step (if ambient atmospheric air is pushed/pulled through the device using a ventilator for the like, this is still considered ambient atmospheric pressure conditions in line with this application, even if the air which is pushed/pulled through the reactor by the ventilator has a pressure slightly above or below the surrounding ambient atmospheric pressure, and the pressure is in the ranges as detailed below in the definition of “ambient atmospheric pressures”);
(b) isolating said sorbent material with adsorbed carbon dioxide in said unit from said flow-through, preferably while essentially maintaining the temperature in the sorbent;
(c) inducing an increase of the temperature of the sorbent material, preferably to a temperature between 6° and 110° C., starting the desorption of CO2. This is e.g. possible by injecting a stream of partially of fully saturated or superheated steam, preferably by flow-through the unit and over/through the sorbent, and thereby inducing an increase of the temperature of the sorbent material to a temperature between 6° and 110° C., starting the desorption of carbon dioxide;
(d) extracting at least the desorbed gaseous carbon dioxide from the unit (preferably most or all of the desorbed gaseous carbon dioxide) and separating gaseous carbon dioxide, preferably by condensation, in or downstream of the unit;
(e) bringing the sorbent material to ambient atmospheric temperature conditions and ambient atmospheric pressure conditions (if the sorbent material is not cooled in this step down to exactly the surrounding ambient atmospheric temperature conditions, this is still considered to be according to this step, preferably the ambient atmospheric temperature established in this step (e) is in the range of the surrounding ambient atmospheric temperature +25° C., preferably +10° C. or +5° C.).

According to one aspect of the invention, the said sorbent material comprises or consists of a packed bed consisting of a mixture of
82-98 wt.-% of first particles of support material functionalised with primary and/or secondary amines, or a combination thereof, capable of reversibly binding carbon dioxide, and
2-18 wt.-% of second particles of support material which are non-functionalised and/or which are functionalised but where the functionalisation is deactivated,
the weight percent of the first and second particles adding up to 100% of the mixture in the packed bed.

Of course, the term mixture necessarily implies that said first particles of support material have to be different from said second particles of support material. So e.g. the first particles are not deactivated or at least not deactivated to the extent as defined further below, in particular in case the second particles of support material are deactivated. I.e. the second particles normally have an equilibrium carbon dioxide capture capacity of less than 85% or 80% or 75% of the equilibrium carbon dioxide capture capacity of the particles which was available initially from the functionalization e.g. before any deterioration.

In the context of this disclosure, the expressions “ambient atmospheric pressure” and “ambient atmospheric temperature” refer to the pressure and temperature conditions to that a plant that is operated outdoors is exposed to, i.e. typically ambient atmospheric pressure stands for pressures in the range of 0.8 to 1.1 barabs and typically ambient atmospheric temperature refers to temperatures in the range of −40 to 60° C., more typically −30 to 45° C.

The gas mixture used as input for the process is preferably ambient atmospheric air, i.e. air at ambient atmospheric pressure and at ambient atmospheric temperature, which normally implies a CO2 concentration in the range of 0.03-0.06% by volume, and a relative humidity in the range of 3-100%. However, also air with lower relative humidity, i.e. <3%, or with lower or higher CO2 concentration can be used as input for the process, e.g. with a concentration of 0.1-0.5% CO2 by volume, so generally speaking, preferably the input CO2 concentration of the input gas mixture is in the range of 0.01-0.5% by volume.

A “packed bed” according to the invention is an assembly of said first and second particles in a defined and confined volume in space and contained therein in a way, which allows the gas mixture to penetrate and/or flow across the surface of the corresponding packed bed.

The first and second particles in the packed bed are not glued together or forming a structure in which the particles adhere to each other, but at least the initial stage of such a packed bed is that the first and second particles are just loosely contained in the corresponding volume in space and do not have any coherence or form any kind of self-supporting structure.

Typically, and preferably, the first particles of support material functionalised (on the surface and/or in the bulk) with primary and/or secondary amines, or a combination thereof, capable of reversibly binding CO2, are ion exchange resin (IER) particles, which can either be manufactured at the desired size or which can be ground before the mixing process to the desired size.

A “non-functionalised surface” in the context of the present invention means that corresponding particles do not have a functionalisation with primary and/or secondary amines, or a combination thereof, capable of reversibly binding carbon dioxide. The corresponding particles can be of the type as detailed further below for the first particles but simply without the additional step of surface/bulk functionalisation. However, they can also be completely different particles, provided they are made of a material which withstands the mechanical and/or temperature conditions of the carbon dioxide capture process. Suitable are for example particles made of polyolefin (for example polyethylene, polypropylene, also ultrahigh molecular weight forms thereof), PET (polyethylene terephthalate), PS (polystyrene), PMMA, (poly(methyl methacrylate) PLA (polylactic acid), PU (polyurethane), polycarbonate, polyamide, polyvinyl chloride, or mixtures thereof. Generally polymeric, preferably thermoplastic or thermoset materials, are suitable. Also inorganic particles are possible as second particles of support material which are non-functionalised, so for example particles based on SiO₂ (including both silica and quartz), alumina, zeolite, MOF (metal organic framework), COF (covalent organic framework) and combinations thereof.

These types particles also typically have D50 average particle sizes as defined above, so e.g. in the range of 0.15-1.5 mm.

A “functionalised surface where the functionalisation is deactivated” according to the present invention is a particle surface which initially was functionalised, in particular by way of functionalisation with primary and/or secondary amines, or a combination thereof, capable of reversibly binding carbon dioxide, but where this functionalisation has been degraded at least on the outer surface of the particle, contributing to contact with neighbouring particles, by use and for example by oxidation, such that the primary and/or secondary amines are not present anymore there to the corresponding extent.

This deactivation also includes situations, where a particle surface, in particular the outer surface of the particle, contributing to contact with neighbouring particles, which initially was functionalised, in particular by way of functionalisation with primary and/or secondary amines, or a combination thereof, but which was intentionally deactivated, e.g. by reacting the amines with protecting groups (capping).

A particle with such a deactivated functionalisation has an equilibrium carbon dioxide capture capacity of less than 85% or 80% of the equilibrium carbon dioxide capture capacity of the particles which was available initially from the functionalization, preferably of less than 75% or less than 70%, or at most 60% of the particles which was available initially from the functionalization, in particular of the primary and/or secondary amines. Alternatively speaking, and in absolute figures, this means that the equilibrium carbon dioxide capture capacity of the particles which was available initially from the functionalization, so before deterioration, is in the range of 1.5-3.5 mmol/g, and deactivated particles would be ones which have at most 85% (or at most 80%, or at most 75% calculated accordingly) of that capture capacity, so in the range of 1.275-2.975%. This degree of deactivation in terms of equilibrium carbon dioxide capture capacity may seem rather low, but unexpectedly nevertheless shows the effect of avoiding clogging. Without being bound to any explanation, it is assumed that the deactivation in terms of removing the reactive amines on the outer surface of the particle and not so much in the porosity and the bulk in these cases is predominant, leading to the anti-clogging effect, but the functionalization in the porosity and the bulk is still to a large extent available, leading to the good capture values for the mixture despite the presence of the deactivated particles.

This type of second particles can for example be provided by old used particles, previously used for carbon dioxide capture, but which have been degraded significantly, and then can be used for mixing with new particles. It is therefore one aspect of the present invention to repower corresponding packed beds by not replacing the particles of a packed bed completely, but by adding a corresponding new amount of newly functionalised particles and to keep the old used particles as second particles as defined above.

The problem associated with using just the first particles as a packed bed, as has been found unexpectedly and recently, is the formation of solid aggregates, also known as caking, in which a smaller or large number of particles adhere to each other, thereby reducing or even preventing airflow through corresponding lumps of particulate material.

This can and in fact does lead to a significant reduction of the carbon dioxide capture capacity of corresponding packed beds. Without being bound to any explanation it seems the functionalisation of the particles in particular under the cyclic to the capture process seems to contribute significantly to the particles to firmly cling to each other and to form physical and/or chemical adherence mechanisms leading to the corresponding clogging or caking.

One surprising finding of the present invention is the fact that apparently mixing the first particles, which are contributing to the carbon dioxide capture process, with in this respect passive or diluting second particles, which do not have surface contributing to the caking, significantly reduces the clogging and the formation of corresponding aggregates, does not impair the carbon dioxide capture capacity of the whole packed bed in spite of the reduction of total number of particles which actually contribute to the carbon dioxide capture process.

It is very important to note that for the case where the second particles of support material are deactivated, what is claimed is not the situation where the sorbent material (e.g. the packed bed of particles) as a whole has been subjected for example for a certain amount of time to a carbon dioxide capture process and where the sorbent material as a whole has deteriorated. In that case, so for example using a prior art process according to WO-A-2022013197 for a certain amount of time, the result is not a mixture of two different types of particles, but all particles are the same and have deteriorated in the respective degree depending on how long the whole packed bed has been subjected to the respective process. In the case of such a deteriorated packed bed there are no mixtures of particles which are not deactivated and particles which are deactivated. All particles are of the same nature and quality, and in fact in such a homogeneous bed the caking problems are not surmounted.

The caking problems while at the same time keeping the carbon dioxide capture capacity high can only be tackled by using a corresponding mixture as claimed, so combining first particles which are not deactivated, so which at least have a carbon dioxide capture capacity which is sufficiently higher than the one of the (deactivated) secondary particles, with the secondary particles in a (essentially homogeneous) mixture.

Preferably the difference in equilibrium carbon dioxide capture capacity between the first particles and the second (preferably deactivated) particles is at least 5% or at least 10%, preferably at least 12% or at least 15%, or at least 20%, in each case taking the equilibrium carbon dioxide capture capacity of the particles which was available initially from the functionalization as 100%. Absolutely speaking for the primary particles, this means that typically the equilibrium carbon dioxide capture capacity of the first particles is at least 85%, typically at least 90% or at least 95% of the equilibrium carbon dioxide capture capacity of the particles which was available initially from the functionalization.

According to a first preferred embodiment, the packed bed consists of a mixture of
85-95 wt.-%, preferably 88-95 wt.-% of first particles, and
5-15 wt.-%, preferably 5-12 wt.-% of second particles,
the weight percent of the first and second particles adding up to 100% of the mixture in the packed bed.

According to yet another preferred embodiment, the support material of the first particles is the same as the support material of the second particles.

Further preferably, in particular for the situation where the support material of both types of particles is the same, the support material is an organic cross linked polymeric polystyrene based support material, in case of the first particles functionalised on the surface and/or in the bulk with primary or secondary amines, or a combination thereof, or in case of the second particles initially functionalised on the surface and/or in the bulk with primary or secondary amines, or a combination thereof but deactivated, preferably oxidised, or the second particles are based on the same support material but have not been functionalised at all.

Preferably the support material (preferably for both, the first and the second particles) is based on polymeric polystyrene cross-linked by divinylbenzene, wherein further preferably the polystyrene-based support material is a styrene divinylbenzene copolymer, preferably in case of said first particles to form the sorbent material surface and/or in the bulk functionalised with primary amine, preferably methyl amine, most preferably benzylamine moieties.

Such solid polymeric support material is preferably obtained in a suspension polymerisation process.

The first particles and the second particles are preferably based on the same starting support material particles having the same particle size characteristics, and the first particles before mixing have been functionalised, and wherein the second particles have been functionalised and then deactivated, preferably by oxidation.

According to another preferred embodiment, the first particles and the second particles are based on the same starting support material, the particles having the same particle size characteristics, and the first particles have been functionalised before mixing, while the second particles are used directly without functionalisation.

Preferably step c) involves injecting a stream of partially of fully saturated or superheated steam, preferably by flow-through through said unit for heating the sorbent.

The contacting of the sorbent with said gas mixture in step (a) further preferably takes place by flow over and/or by flow through.

Typically, the mean particle size (D50) of the first and/or second particles is in the range of 0.002-4 mm, or 0.15-1.5 mm, preferably 0.005-2 mm, or 0.002-1.5 mm, 0.005-1.6 mm or 0.01-1.5 mm, most preferably in the range of 0.30-1.25 mm.

The first particles of support material functionalised on the surface and/or in the bulk with primary or secondary amines, or a combination thereof, capable of reversibly binding CO2 further preferably have a nitrogen content in the range 4-50 wt. %, preferably in the range of 5-25 wt. % or 5-15 wt. % or 6-12 wt. %, in each case for dry sorbent material.

The gas mixture used in the above method is preferably ambient atmospheric air.

Said mixture is preferably contained in preferably layered containers having air permeable side walls in the form of grids, having a mesh width smaller than the average particle size or smaller than the particle size of the 10% smallest particles (D10) in the mixture so that the particles of the mixture are retained in the corresponding containers.

According to yet another aspect of the present invention, it relates to a packed bed for separating gaseous carbon dioxide from a gas mixture, preferably from at least one of ambient atmospheric air, flue gas and biogas, containing said gaseous carbon dioxide as well as further gases different from gaseous carbon dioxide, by cyclic adsorption/desorption, preferably for use in a method as defined above,
wherein the packed bed consists of a mixture of
82-98 wt.-% of first particles of support material functionalised with primary or secondary amines, or a combination thereof, capable of reversibly binding carbon dioxide, and
2-18 wt.-% of second particles of support material which are non-functionalised and/or which are functionalised but where the functionalisation is deactivated,
the weight percent of the first and second particles adding up to 100% of the mixture in the packed bed.

According to yet another aspect of the present invention, it relates to the use of a packed bed as defined above for separating gaseous carbon dioxide from a gas mixture, preferably from at least one of ambient atmospheric air, flue gas and biogas, containing said gaseous carbon dioxide as well as further gases different from gaseous carbon dioxide, by cyclic adsorption/desorption.

Last but not least the present invention also relates to a method of making a packed bed as defined above, wherein support material particles are provided, a fraction thereof is functionalised to generate the first particles, and a second fraction thereof is not functionalised and/or is functionalised and subsequently deactivated to generate the second particles, and the first and second particles are mixed and packed to form the packed bed, preferably by inserting into a container having air permeable side walls, preferably in the form of grids having a mesh width suitable and adapted to retain the mixture in the container.

As already pointed out above, it's also possible to use old particles which previously have been used as carbon dioxide capture particles, but which have been significantly oxidised so as not to show any significant carbon dioxide capture capacity anymore, as secondary particles. In a repowering process, according to this method are packed bed is reconstituted or repowered by taking the old material out of the corresponding container, keeping only 2-18 wt.-% of the used and not active particles and adding the corresponding complimentary amount of newly functionalised particles to the corresponding packed bed.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematic representation of a direct air capture unit;

FIG. 2 shows the carbon dioxide uptake capacity as a function of time, for first particles (starting material) and for second particles in the form of oxidised material, but not in a mixture but as sole particles in the packed bed, wherein in a) the time window of 0-600 minutes and in b) the time window of 0-180 minutes is given;

FIG. 3 shows the carbon dioxide uptake at 180 minutes for a mixture of functionalised sorbent particles with functionalised but oxidised sorbent particles as a function of the oxidised sorbent particles proportion;

FIG. 4 shows the carbon dioxide uptake at 180 minutes for a mixture of functionalised sorbent particles with non-functionalised sorbent particles as a function of the non-functionalised sorbent particles proportion.

### DESCRIPTION OF PREFERRED EMBODIMENTS

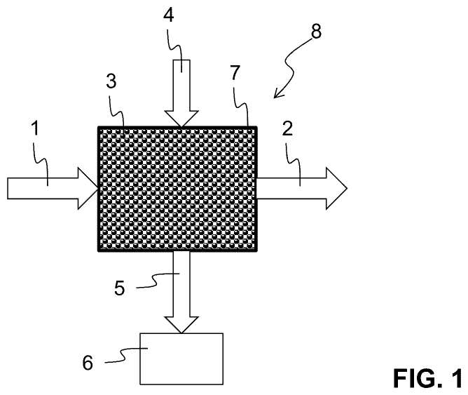

Cyclic adsorption performance: The packed beds according to the examples below were tested in an experimental rig. The rig is schematically illustrated in FIG. 1. There is an ambient air inflow structure 1. The actual reactor unit 8 comprises a container or wall 7 within which the packed bed forming the sorbent material 3 described above is located. There is an inflow structure 4 for desorption, where steam and/or heat are used for desorption, and there is a reactor outlet 5 for extraction. Further, there is a vacuum unit 6 for optional evacuating the reactor. Such experimental rig was used for characterising the cyclic adsorption performance.

The sorbent particles: The particles employed are based on porous divinyl benzene crosslinked polystyrene beads (d~0.3-1.5 mm), in case of the first particles functionalised with amino methyl-groups to form benzyl amine moieties which can be introduced e.g. in an chloromethylation reaction followed by amination with urotropine or by phtalimide addition followed by hydrolysis.

The functionalised particles can by synthesized as follows: In a 1 L reactor, 1% (mass ratio) of gelatin and 2% (mass ratio) of sodium chloride are dissolved in 340 ml of water at 45° C. for 1 h. In another flask, 1 g of benzoyl peroxide is dissolved in a mixture of 59.7 g of styrene, 3.9 g of divinylbenzene (content 80%) and 65.3 g of C11-C13 iso-paraffin. The resulting mixture is then added to the reactor. After that the reaction mixture is stirred and heated up to 70° C. maintaining the temperature for 2 h, then the temperature is raised to 80° C. and kept it for 3 h, and then raised to 90° C. for 6 h. The reaction mixture is cooled down to room temperature and the beads are filtered off using a funnel glass filter and vacuum suction.

The beads are washed with toluene and dried in rotavapor.

The polystyrene-divinylbenzene beads are functionalised using the chloromethylation reaction. 5 g of so obtained beads are added to a 3-neck flask containing 50 ml of chloromethyl methyl ether. The mixture is stirred for 1 h, 2 g of zinc chloride is added and is heated to 40° C. and kept it for 24 h. After that, the beads are filtered off and washed with 25% HCl and water to obtain chloromethylated beads. To obtain benzylamine units, the chloromethylated beads are aminated using the following procedure. The chloromethylated beads are added to a three-necked flask with 27 g of methylal and the mixture is stirred for 1 h. To this mixture, 16 g of hexamethylenetetramine and 13 g of water are added and kept under gentle reflux for 24 h. The beads are filtered off and washed with water. To have a primary amine, a hydrolysis step followed by a treatment with a bases are required. The beads are placed in a 3-neck flask containing 140 ml of a solution of hydrochloric acid (30%)-ethanol (95%) (volume ratio of 1:3), the reaction mixture is heated to 80° C. and kept at this temperature for 20 h. After that, the beads are filtered off and washed with water.

At this stage the amine is protonated and to free the base, the beads are treated with 50 mL of an NaOH solution 2 M, and stirred with 1 h at 80° C. The aminated beads are filter off and washed to neutral pH with demineralized water.

Caking experiments: The caking experiments were performed on a commercial breakthrough analyser device with a customisation to allow running sequences of adsorption and desorption. Climatisation of the reactor was done with a jacketed reactor which was attached to a heating and cooling unit. For the experiments an isochoric chamber insert (V=20 mL) was built that allows flow through of process gasses.

In a standard experiment, the above first particles were mixed with an aliquot amount of the respective second particles and then filled into the isochoric chamber. The content was gently tapped on the side and bottom in order to compact the sorbent bed. The excess amount was scraped off to ensure a plain surface. The cell was then tightly closed and placed into the jacketed reactor. The cell was further fixed with an o-ring in the reactor to avoid bypassing.

The gas composition was then set as follows:
Adsorption: air (2 ml/min) at 450 ppm of CO2 at 9° C. and 95 RH for 3 hours, the CO2 break through was recorded
Desorption: N2 (2 mL/min) at 90° C. for 45 min

The sorbent bed was initially desorbed followed by adsorption for in total five repetitions.

After the experiment, the chamber was opened and the state of the sorbent bed was evaluated qualitatively, for amount and stability of cakes in the sorbent bed. The uptake was then evaluated from the breakthrough curves recorded by the device.

Preparation of oxidised particles: First particles were placed in a petri dish and kept in ambient air at 95° C. for 72 hours. The particles were then cooled to room temperature and used as is.

The deactivated particles used as second particles showed an equilibrium CO2 capture capacity of 60% relative to the capacity of the initial particles.

Carbon Dioxide Capture Performance of Sorbent material: Equilibrium capacity and 180 min capacity were measured in a custom-made break through analyser. A loose bed of sorbent was loosely poured into a measuring cell and then the breakthrough was analysed at 30° C. and 60% RH.

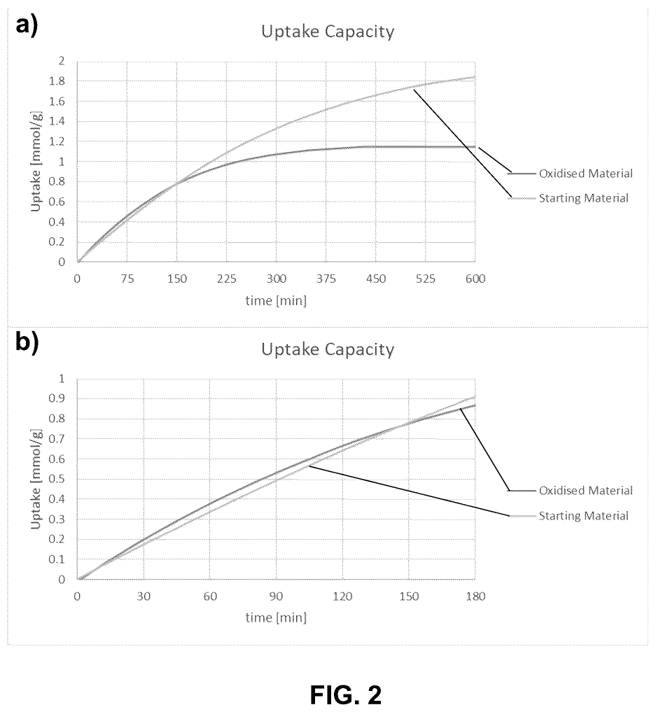

The results are illustrated in FIG. 2, showing the carbon dioxide uptake as a function of the adsorption time for the oxidised particles and for the functionalised first particles (designated as Starting material), wherein in a) the time window of 0-600 minutes is given and in b) the time window between zero and 180 minutes.

As one can see, in particular for long adsorption times the oxidised material significantly loses uptake capacity.

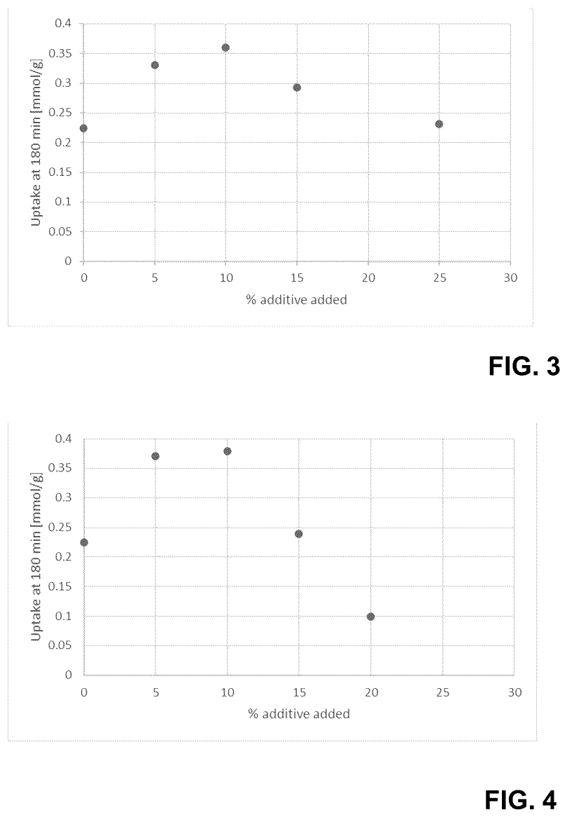

FIG. 3 shows the carbon dioxide uptake at an uptake time of 180 minutes for a packed bed, in which the first particles are functionalised particles as given above, and the second particles are oxidised functionalised particles as given above, the uptake is given as a function of the proportion of the second particles, in each case the first particles complementing to 100%.

As one can see from this figure, surprisingly despite adding deactivated sorbent particles, the overall uptake increases and there is an optimum window for the addition of these anticaking second particles between 2-18% by weight, with a preferred range given by the window of about 5-12%.

The results for the uptake as well as for the caking are given in Table 1 below.

TABLE 1
results for uptake and caking for a mixture of functionalised
with functionalised but oxidised particles

| | 180 min Uptake | | Caking |
|---|---|---|---|
| First particles, | 0.22 | mmol/g | ++ |
| Fresh | | | Predominantly cakes / Hard |
| | | | to the touch |
| First particles + | 0.33 | mmol/g | ++ |
| 5% Oxidised | | | Cakes / Hard to the touch |
| First particles + | 0.36 | mmol/g | + |
| 10% Oxidised | | | Few Cakes / Hard to the |
| | | | touch |
| First particles + | 0.29 | mmol/g | − |
| 15% Oxidised | | | Few Cakes / Soft to the |
| | | | touch |
| First particles + | 0.23 | mmol/g | −− |

| | |
|---|---|
| 25% Oxidised | Almost no cakes / Soft to |
| | the touch |

FIG. 4 shows the carbon dioxide uptake at a uptake time of 180 minutes for a packed bed, in which the first particles are functionalised particles as given above, and the second particles are non-functionalised particles (the same particles as the first particles but not having been subjected to the functionalisation), the uptake is given as a function of the proportion of the second particles, in each case the first particles complementing to 100%. As one can see from this figure, surprisingly despite adding deactivated sorbent particles, the overall uptake increases with addition of and there is an optimum window for the addition of these anticaking second particles again between 2-18% by weight, with a preferred range given by the window of about 5-12%.

The results for the uptake as well as for the caking are given in table 2 below.

TABLE 2
results for uptake and caking for a mixture of functionalised
with functionalised but oxidised particles

| | 180 min Uptake | | Caking |
|---|---|---|---|
| First particles | 0.22 | mmol/g | ++ |
| | | | Predominantly cakes / Hard |
| | | | to the touch |
| First particles + 5% | 0.37 | mmol/g | ++ |
| unfunctionalised particles | | | Cakes / Hard to the touch |
| First particles + 10% | 0.38 | mmol/g | + |
| unfunctionalised particles | | | Few Cakes / Hard to the |
| | | | touch |
| First particles + 15% | 0.24 | mmol/g | −− |
| unfunctionalised particles | | | No Cakes |
| First particles + 20% | 0.10 | mmol/g | −− |

| | |
|---|---|
| unfunctionalised particles | No cakes |

LIST OF REFERENCE SIGNS

| | |
|---|---|
| 1 | Ambient air, ambient air |
| | inflow structure |
| 2 | Outflow of ambient air behind |
| | adsorption unit in adsorption |
| | flow-through mode |
| 3 | Sorbent material |
| 4 | Heat and/or steam, heat |
| | and/or steam inflow structure |
| | for heat/steam desorption |
| 5 | Reactor outlet for extraction |
| 6 | Vacuum unit/separator |
| 7 | Wall |
| 8 | Reactor unit |

1. A method for separating gaseous carbon dioxide from a gas mixture, containing said gaseous carbon dioxide as well as further gases different from gaseous carbon dioxide, by cyclic adsorption/desorption using a sorbent material adsorbing said gaseous carbon dioxide in a unit,
wherein the method comprises at least the following sequential and in this sequence repeating steps (a)-(e):
(a) contacting said gas mixture with the sorbent material to allow at least said gaseous carbon dioxide to adsorb on the sorbent material by flow-through through said unit essentially under ambient atmospheric pressure conditions and ambient atmospheric temperature conditions in an adsorption step;
(b) isolating said sorbent material with adsorbed carbon dioxide in said unit from said flow-through;
(c) inducing an increase of the temperature of the sorbent material, starting the desorption of carbon dioxide;
(d) extracting at least the desorbed gaseous carbon dioxide from the unit and separating gaseous carbon dioxide in or downstream of the unit;
(e) bringing the sorbent material essentially to ambient atmospheric temperature conditions and ambient atmospheric pressure conditions;
wherein said sorbent material comprises or consists of a packed bed consisting of a mixture of
82-98 wt.-% of first particles of support material functionalised with primary or secondary amines, or a combination thereof, capable of reversibly binding carbon dioxide, and
2-18 wt.-% of second particles of support material which are non-functionalised and/or which are functionalised but where the functionalisation is deactivated,
the weight percent of the first and second particles adding up to 100% of the mixture in the packed bed.

2. The method according to claim 1, wherein the packed bed consists of a mixture of
85-95 wt.-% of first particles, and
5-15 wt.-% of second particles,
the weight percent of the first and second particles adding up to 100% of the mixture in the packed bed.

3. The method according to claim 1, wherein the support material of the first particles is the same as the support material of the second.

4. The method according claim 1, wherein the first particles and the second particles are based on the same starting support material particles having the same particle size characteristics, and wherein the first particles before mixing have been functionalised, and wherein the second particles have been functionalised and then deactivated, preferably by oxidation.

5. The method according claim 1, wherein the first particles and the second particles are based on the same starting support material particles having the same particle size characteristics, and wherein the first particles before mixing have been functionalised, and wherein as second particles directly the starting support material particles are used.

6. The method according claim 1, wherein step c) involves injecting a stream of partially of fully saturated or superheated steam.

7. The method according claim 1, wherein the contacting of the sorbent with said gas mixture in step (a) takes place by flow over and/or by flow through.

8. The method according claim 1, wherein the mean particle size (D50) of the first and/or second particles is in the range of 0.002-4 mm.

9. The method according claim 1, wherein the first particles of support material functionalised on the surface and/or in the bulk with primary or secondary amines, or a combination thereof, capable of reversibly binding carbon dioxide have a nitrogen content in the range 4-50 wt. %, in each case, for dry sorbent material.

10. The method according claim 1, wherein the gas mixture is ambient atmospheric air.

11. The method according claim 1, wherein said mixture is contained in containers having air permeable side walls in the form of grids, having a mesh width which is smaller than the average particle size or smaller than the particle size of the 10% smallest particles in the mixture (D10) so that the particles of the mixture are retained in the corresponding containers.

12. A packed bed for separating gaseous carbon dioxide from a gas mixture, containing said gaseous carbon dioxide as well as further gases different from gaseous carbon dioxide, by cyclic adsorption/desorption, for use in a method according to claim 1,
wherein the packed bed consists of a mixture of
82-98 wt.-% of first particles of support material functionalised with primary or secondary amines, or a combination thereof, capable of reversibly binding carbon dioxide, and
2-18 wt.-% of second particles of support material which are non-functionalised and/or which are functionalised but where the functionalisation is deactivated,
the weight percent of the first and second particles adding up to 100% of the mixture in the packed bed.

13. A method of using a packed bed according to claim 12 for separating gaseous carbon dioxide from a gas mixture, containing said gaseous carbon dioxide as well as further gases different from gaseous carbon dioxide, by cyclic adsorption/desorption.

14. A method of making a packed bed according to claim 12, wherein support material particles are provided, a fraction thereof is functionalised to generate the first particles, and a second fraction thereof is not functionalised and/or is functionalised and subsequently deactivated to generate the second particles, and the first and second particles are mixed and packed to form the packed bed.

15. The method according to claim 1, wherein step (c) is inducing an increase of the temperature of the sorbent material, to a temperature between 6° and 110° C., starting the desorption of carbon dioxide.

16. The method according to claim 1, wherein the packed bed consists of a mixture of
88-95 wt.-% of first particles, and
5-12 wt.-% of second particles,
the weight percent of the first and second particles adding up to 100% of the mixture in the packed bed.

17. The method according to claim 3, wherein the support material is an organic cross linked polymeric polystyrene based support material, in case of the first particles functionalised on the surface and/or in the bulk with primary or secondary amines, or a combination thereof, or in case of the second particles initially functionalised on the surface and/or in the bulk with primary or secondary amines, or a combination thereof but deactivated, including oxidised or capped,
and/or wherein the support material is based on polymeric polystyrene cross-linked by divinylbenzene, wherein the polystyrene based support material is a styrene divinylbenzene copolymer, in case of said first particles to form the sorbent material surface and/or in the bulk functionalised with primary amine, including methyl amine or benzylamine moieties, wherein the solid polymeric support material can be obtained in a suspension polymerisation process.

18. The method according to claim 4, wherein the second particles have been functionalised and then deactivated by oxidation.

19. The method according to claim 1, wherein step c) involves injecting a stream of partially of fully saturated or superheated steam by flow-through through said unit for heating the sorbent.

20. The method according to claim 1, wherein the mean particle size (D50) of the first and/or second particles is in the range of 0.01-1.5 mm, or in the range of 0.30-1.25 mm.

21. The method according to claim 1, wherein the first particles of support material functionalised on the surface and/or in the bulk with primary or secondary amines, or a combination thereof, capable of reversibly binding carbon dioxide have a nitrogen content in the range 5-25 wt. % or 5-15 wt. % or 6-12 wt. %, in each case for dry sorbent material.

22. The method according to claim 1, wherein said mixture is contained in layered containers having air permeable side walls in the form of grids, having a mesh width which is smaller than the average particle size or smaller than the particle size of the 10% smallest particles in the mixture (D10) so that the particles of the mixture are retained in the corresponding containers.

23. The packed bed according to claim 12 for separating gaseous carbon dioxide from at least one of ambient atmospheric air, flue gas and biogas, containing said gaseous carbon dioxide as well as further gases different from gaseous carbon dioxide.

24. The Method according to claim 13 for separating gaseous carbon dioxide from at least one of ambient atmospheric air, flue gas and biogas.

25. The Method according to claim 14, wherein the first and second particles are mixed and packed to form the packed bed, by inserting into a container having air permeable side walls, in the form of grids having a mesh width suitable and adapted to retain the mixture in the container.
